(19) United States
(12) Patent Application Publication
(10) Pub. No.: US 2024/0135146 A1
(43) Pub. Date: Apr. 25, 2024

(54) Method and Apparatus for Training Item Copy-writing Generation Network, and Method and Apparatus for Generating Item Copy-writing

(71) Applicants: BEIJING WODONG TIANJUN INFORMATION TECHNOLOGY CO., LTD., Beijing (CN); BEIJING JINGDONG CENTURY TRADING CO., LTD., Beijing (CN)

(72) Inventors: Hainan ZHANG, Beijing (CN); Hongshen CHEN, Beijing (CN); Zhuoye DING, Beijing (CN); Yongju BAO, Beijing (CN); Bo LONG, Beijing (CN)

(21) Appl. No.: 18/273,473

(22) PCT Filed: Jan. 12, 2022
(86) PCT No.: PCT/CN2022/071588

§ 371 Date: Jul. 20, 2023

(30) Foreign Application Priority Data
Jan. 21, 2021 (CN) 202110084578.X

(51) Int. Cl. G06N 3/0455; G06N 3/096

(52) U.S. Cl. CPC G06N 3/0455; G06N 3/096

(57) ABSTRACT

The present disclosure provides a method and apparatus for training an item copy-writing generation network. The method includes: obtaining item description information of each item in an item set; carrying out data preprocessing on an item description information set corresponding to the item set, to obtain a processed item description information set; training an initial first item copy-writing generation network, to obtain a trained first item copy-writing generation network; and training an initial second item copy-writing generation network through a knowledge distillation method, to obtain a trained second item copy-writing generation network.

### CROSS-REFERENCE TO RELATED APPLICATIONS

This patent application is a National Stage of International Application No. PCT/CN2022/071588. This application claims the priorities from PCT Application No.: PCT/CN2022/071588, filed on Jan. 12, 2022, and from Chinese Patent Application No. 202110084578.X, filed on Jan. 21, 2021, and entitled “method and apparatus for training item copy-writing generation network, and method and apparatus for generating item copy-writing”, the entire disclosures of which are hereby incorporated by reference.

### TECHNICAL FIELD

Examples of the present disclosure relate to the technical field of computers, and in particular to a method and apparatus for training an item copy-writing generation network, a method and apparatus for generating an item copy-writing, an electronic device and a computer-readable medium.

### BACKGROUND

At present, a traditional use of an item search and recommendation technology has been far from satisfying an increasing demand of a user. The user often faces the problem of information explosion when browsing a recommendation system. In light of that, excellent item copies are expected to rapidly find out products needed by the user, so as to save cost.

### SUMMARY

The content of the present disclosure is intended to briefly introduce the concepts, which will be described in detail in the detailed description of the embodiments below. The content of the present disclosure is not intended to identify key or necessary features of the technical solution, and is also not intended to limit the scope of the technical solution.

In a first aspect, a method for training an item copy-writing generation network is provided in some examples of the present disclosure. The method includes: obtaining item description information of each item in an item set, where the item description information described above includes: title information of the item, attribute information of the item, and at least one piece of comment information on the item; carrying out data preprocessing on an item description information set corresponding to the item set described above to obtain a processed item description information set; training an initial first item copy-writing generation network, to obtain a trained first item copy-writing generation network, where a training sample corresponding to the initial first item copy-writing generation network described above includes: item description information in the processed item description information set described above and an item copy-writing corresponding to the item description information, where the item copy-writing described above is pre-written; and with the title information and the attribute information of each piece of item description information in the processed item description information set described above and the item copy-writing corresponding to each piece of item description information described above as a training sample for an initial second item copy-writing generation network, training, according to the trained first item copy-writing generation network described above, the initial second item copy-writing generation network described above through a knowledge distillation method, to obtain a trained second item copy-writing generation network.

In a second aspect, a method for generating an item copy-writing is provided in some examples of the present disclosure. The method includes: obtaining title information and attribute information of a target item; and inputting the title information described above and the attribute information described above into a trained second item copy-writing generation network, to obtain an item copy-writing corresponding to the target item described above, where the trained second item copy-writing generation network described above is obtained by training an initial second item copy-writing generation network according to a trained first item copy-writing generation network through a knowledge distillation method.

In a third aspect, an apparatus for training an item copy-writing generation network is provided in some examples of the present disclosure. The apparatus includes: an obtaining unit configured to obtain item description information of each item in an item set, where the item description information described above includes: title information of the item, attribute information of the item, and at least one piece of comment information on the item; a preprocessing unit configured to carry out data preprocessing on an item description information set corresponding to the item set described above to obtain a processed item description information set described above; a first training unit configured to train an initial first item copy-writing generation network, to obtain a trained first item copy-writing generation network, where a training sample corresponding to the initial first item copy-writing generation network described above includes: item description information in the processed item description information set described above and an item copy-writing corresponding to the item description information, where the item copy-writing described above is pre-written; and a second training unit configured to train, according to the trained first item copy-writing generation network, the initial second item copy-writing generation network described above through a knowledge distillation method with the title information and the attribute information of each piece of item description information in the processed item description information set described above and the item copy-writing corresponding to each piece of item description information described above as a training sample for an initial second item copy-writing generation network, to obtain a trained second item copy-writing generation network.

In a fourth aspect, an apparatus for generating an item copy-writing is provided in some examples of the present disclosure. The apparatus includes: an obtaining unit configured to obtain title information and attribute information of a target item; and an input unit configured to input the title information described above and the attribute information described above into a trained second item copy-writing generation network, to obtain an item copy-writing corresponding to the target item described above, where the trained second item copy-writing generation network described above is obtained by training an initial second item copy-writing generation network according to a trained first item copy-writing generation network through a knowledge distillation method.

In a fifth aspect, an electronic device is provided in some examples of the present disclosure. The electronic device includes: one or more processors; and a storage apparatus configured to store one or more programs, where when the one or more programs are executed by the one or more processors, the one or more processors implement the method of any one of the first aspect or the second aspect.

In a sixth aspect, a computer-readable medium is provided in some examples of the present disclosure. The computer-readable medium stores a computer program, where the program implements the method of any one of the first aspect or the second aspect when executed by a processor.

### BRIEF DESCRIPTION OF THE DRAWINGS

What are described above of each example of the present disclosure and other features, advantages, and aspects will become more apparent in combination with the accompanying drawings and with reference to the following particular embodiments. Throughout the accompanying drawings, identical or similar reference numerals represent identical or similar elements. It should be understood that the accompanying drawings are schematic, and components and elements are not necessarily drawn to scale.

FIG. 1 is a schematic diagram of an application scenario of a method for training an item copy-writing generation network according to some examples of the present disclosure;

FIG. 2 is a flow chart of some examples of a method for training an item copy-writing generation network according to the present disclosure;

FIG. 3 is a schematic diagram of an application scenario of a method for generating an item copy-writing according to some examples of the present disclosure;

FIG. 4 is a flow chart of some examples of a method for generating an item copy-writing according to the present disclosure;

FIG. 5 is a schematic structural diagram of some examples of an apparatus for training an item copy-writing generation network according to the present disclosure;

FIG. 6 is a schematic structural diagram of some examples of an apparatus for generating an item copy-writing according to the present disclosure; and

FIG. 7 is a schematic structural diagram of an electronic device suitable for implementing some examples of the present disclosure.

### DETAILED DESCRIPTION

The examples of the present disclosure will be described in more detail below with reference to the accompanying drawings. Although some examples of the present disclosure are shown in the accompanying drawings, it should be understood that the present disclosure can be implemented in various forms and should not be limited to the examples described herein. On the contrary, these examples are provided for a more thorough and complete understanding of the present disclosure. It should be understood that the accompanying drawings and the examples of the present disclosure are only for illustrative functions and are not intended to limit the scope of protection of the present disclosure.

In addition, it should further be noted that for the convenience of description, only the parts related to the related invention are shown in the accompanying drawings. The examples in the present disclosure and the features in the examples can be combined with each other without conflict.

It should be noted that the concepts such as “first” and “second” mentioned in the present disclosure are only used to distinguish different apparatuses, modules or units, and are not intended to define the order or interdependence of the functions executed by these apparatuses, modules or units.

It should be noted that the modifications of “one” and “a plurality of” mentioned in the present disclosure are illustrative rather than restrictive, and those skilled in the art should understand that unless otherwise explicitly stated in the context, “one” and “a plurality of” should be understood as “one or more”.

The names of messages or information interacted between a plurality of apparatuses in the embodiment of the present disclosure are for illustrative purposes only and are not intended to limit the scope of these messages or information.

A related method for generating a copy, such as manually analyzing a title, attribute, and other content information of an item, as well as comment information on an item to generate an item copy-writing, often has the following technical problem: most items have a small amount of or low-value comment information, such that a high-quality item copy-writing may not be effectively generated according to the comment information.

In order to solve the problem described above, a method and apparatus for training an item copy-writing generation network are provided in some examples of the present disclosure. A trained first item copy-writing generation network can guide an initial second item copy-writing generation network to be trained to generate an item copy-writing such that the trained second item copy-writing generation network can accurately and effectively generate the item copy-writing according to title information of an item and attribute information of the item.

The present disclosure will be described in detail below with reference to the accompanying drawings and in combination with the examples.

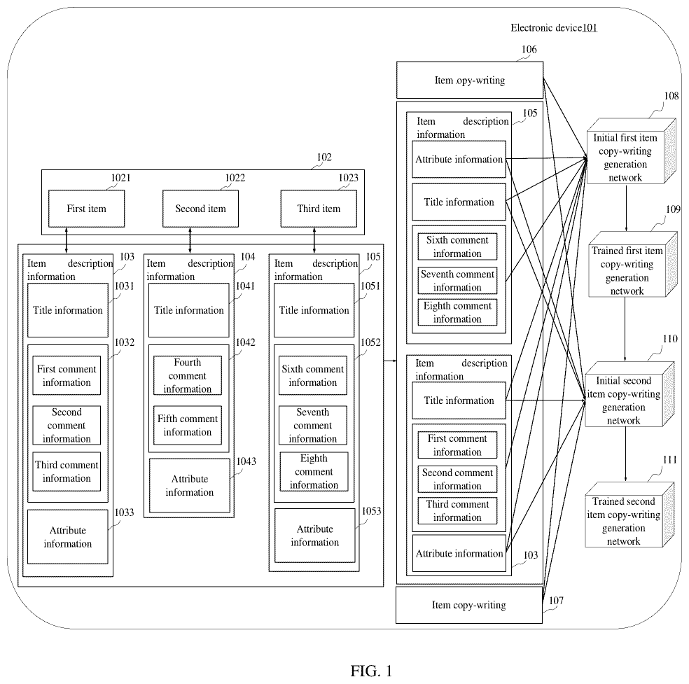

FIG. 1 is a schematic diagram of an application scenario of a method for training an item copy-writing generation network according to some examples of the present disclosure.

As shown in FIG. 1, an electronic device 101 may obtain item description information of each item in an item set 102. The item description information described above includes: title information of the item, attribute information of the item, and at least one piece of comment information on the item. In the application scenario, the item set 102 described above includes: a first item 1021, a second item 1022 and a third item 1023. The first item 1021 described above corresponds to item description information 103. The second item 1022 described above corresponds to item description information 104. The third item 1023 described above corresponds to item description information 105. The item description information 103 described above includes: title information 1031, attribute information 1033, and at least one piece of comment information 1032. The at least one piece of comment information 1032 described above includes: first comment information, second comment information and third comment information. The item description information 104 described above includes: title information 1041, attribute information 1043, and at least one piece of comment information 1042. The at least one piece of comment information 1042 described above includes: fourth comment information and fifth comment information. The item description information 105 described above includes: title information 1051, attribute information 1053, and at least one piece of comment information 1052. The at least one piece of comment information 1052 described above includes: sixth comment information, seventh comment information and eighth comment information. Then, the electronic device carried out data preprocessing on the item description information set corresponding to the item set 102 described above to obtain a processed item description information set. In the application scenario, the processed item description information set described above includes: the item description information 103 and the item description information 105. Further, an initial first item copy-writing generation network 108 is trained to obtain a trained first item copy-writing generation network 109. A training sample corresponding to the initial first item copy-writing generation network 108 described above includes: item description information in the processed item description information set described above and an item copy-writing corresponding to the item description information. The item copy-writing described above is pre-written. In the application scenario, a training sample set of the initial first item copy-writing generation network 108 described above may include: a training sample consisting of the item description information 105 and the item copy-writing 106, and a training sample consisting of the item description information 103 and the item copy-writing 107. Finally, with the title information and the attribute information of each piece of item description information in the processed item description information set described above and the item copy-writing corresponding to each piece of item description information described above as a training sample for an initial second item copy-writing generation network 110, the initial second item copy-writing generation network 110 described above is trained according to the trained first item copy-writing generation network 109 described above through a knowledge distillation method, to obtain a trained second item copy-writing generation network 111. In the application scenario, a training sample set of the initial second item copy-writing generation network 110 includes: a training sample consisting of the item copy-writing 106, the attribute information in the item description information 105, and the title information in the item description information 105, and a training sample consisting of the item copy-writing 107, the attribute information in the item description information 103, and the title information in the item description information 103.

It should be noted that the electronic device 101 described above may be hardware or software. When the electronic device is the hardware, the electronic device may be implemented as a distributed cluster consisting of a plurality of servers or terminal devices, or may be implemented as a single server or a single terminal device. When the electronic device is embodied as the software, the electronic device may be mounted in the above-listed hardware device. The electronic device may be implemented as a plurality of software or software modules configured to provide a distributed service, for example, or as a single software or software module, which is not specifically limited herein.

It should be understood that the number of electronic devices in FIG. 1 is merely illustrative. Any number of electronic devices may be provided according to implementation requirements.

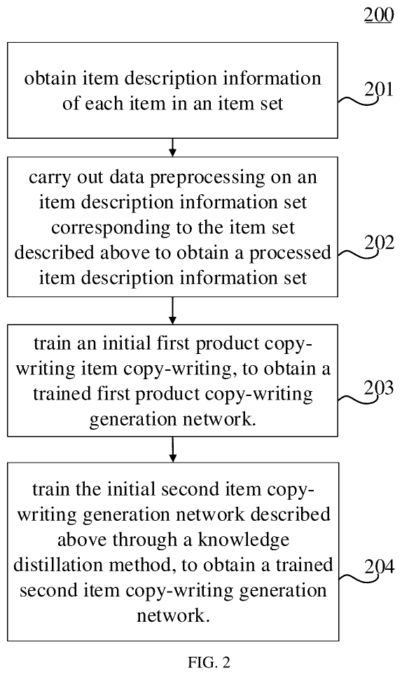

Further, reference is made to FIG. 2 showing a flow 200 of some examples of a method for training an item copy-writing generation network according to the present disclosure. The method for training an item copy-writing generation network includes:
step 201, obtain item description information of each item in an item set.

In some examples, an execution body (for example, the electronic device 101 shown in FIG. 1) of the method for training an item copy-writing generation network may obtain the item description information of each item in the item set in a wired connection manner or a wireless connection manner. The item description information described above includes: title information of the item, attribute information of the item, and at least one piece of comment information on the item. The title information of the item described above may be a short sentence indicating contents of the item. The attribute information of the item described above may include, but not limited to, at least one of the following: function information of the item, appearance color information of the item, material information of the item, and style information to which the item belongs.

As an example, the item described above may be a shoe.

The title information of the item may be: “special price style, ***official flagship, ***joint women's shoes vintage canvas shoes, women's shoes, covered shoes, white red”.

The attribute information of the item may be:
“function: breathable and hard-wearing;
style: casual;
color: white, black and blue; and
upper material: fabric”.

The comment information on the item may be:
“shoes are extremely breathable and have an extremely nice color”,
“the shoes are fashionable and economical”, and
“shoes are of high quality but require long delivery time”.

It should be noted that the wireless connection manner described above may include, but not limited to, third generation (3G)/fourth generation (4G)/fifth generation (5G) connection, wireless fidelity (WiFi) connection, Bluetooth connection, world interoperability for microwave access (WiMAX) connection, Zigbee connection, ultra wideband (UWB) connection, and other wireless connection manners currently known or developed in the future.

Step 202, carry out data preprocessing on an item description information set corresponding to the item set described above to obtain a processed item description information set.

In some examples, the execution body described above may perform data preprocessing on the item description information set corresponding to the item set described above to obtain the processed item description information set.

In some alternative embodiments of some examples, the step of carrying out data preprocessing on an item description information set corresponding to the item set described above to obtain a processed item description information set may include:
step 1, determine the number of pieces of the comment information on each piece of item description information in the item description information set described above. As an example, the execution body described above may determine the number of pieces of the comment information on each piece of item description information in the item description information set described above by querying a database that stores the comment information.
Step 2, remove the item description information of which the number of pieces of the comment information is less than a predetermined threshold from the item description information set described above to obtain a removed item description information set. As an example, the predetermined threshold described above may be a value “3”.
Step 4, remove, from each piece of item description information in the removed item description information set described above, comment information of which comment contents satisfy a predetermined condition to generate processed item description information, so as to obtain the processed item description information set described above. The comment contents described above satisfying the predetermined condition may be contents satisfying a predetermined template or contents that does not have too much reference value.

Step 203, train an initial first item copy-writing generation network, to obtain a trained first item copy-writing generation network.

In some examples, the execution body described above trains the initial first item copy-writing generation network, to obtain the trained first item copy-writing generation network. A training sample corresponding to the initial first item copy-writing generation network described above includes: item description information in the processed item description information set described above and an item copy-writing corresponding to the item description information. The item copy-writing described above is pre-written. It should be noted that a process of training the initial first item copy-writing generation network described above is a currently conventional training step, which will not be repeated herein.

Step 204, train the initial second item copy-writing generation network described above through a knowledge distillation method, to obtain a trained second item copy-writing generation network.

In some examples, the execution body described above may use the title information and the attribute information of each piece of item description information in the processed item description information set described above as training data in the training sample and the item copy-writing corresponding to each piece of item description information described above as a labeling of the training data in the training sample, according to the trained first item copy-writing generation network described above, the initial second item copy-writing generation network described above is trained by utilizing the knowledge distillation method, to obtain the trained second item copy-writing generation network. A first item copy-writing generation network may be a Teacher network in a Teacher-Student network. Correspondingly, a second item copy-writing generation network may be a Student network in the Teacher-Student network. The knowledge distillation method described above may utilize transfer knowledge to obtain a small model more suitable for inference by means of a trained large model.

It should be noted that the training sample for the trained first item copy-writing generation network includes comment information on the item. Therefore, the trained first item copy-writing generation network may learn to generate a high-quality item copy-writing by means of the title information, the attribute information and at least one piece of comment information on the item description information. However, in a recommendation system, most items have a small amount of comment information, such that quality of the item copy-writing generated according to the trained first item copy-writing generation network is insufficient. Further, the first item copy-writing generation network is used as the Teacher network, and the second item copy-writing generation network is used as the Student network. A training sample for the second item copy-writing generation network includes title information and attribute information of the item description information, but does not include comment information on the item. The trained first article copy generation network guides the second article copy generation network to be trained, such that the second item copy-writing generation network learns knowledge of generating the high-quality item copy-writing from the trained first item copy-writing generation network.

In some alternative embodiments of some examples, the initial second item copy-writing generation network described above is trained with a Kullback Leibler (KL) distance set between a conditional probability corresponding to a first target vector output from the trained first item copy-writing generation network described above and a conditional probability set corresponding to a second target vector set output from the second item copy-writing generation network as a training constraint condition to obtain the trained second item copy-writing generation network described above. The conditional probability corresponding to the first target vector may be p(yₜ|Hᵢₜₑₘ). yₜ may be a t-th word of the item copy-writing generated. Hᵢₜₑₘ may be the first target vector corresponding to the item. The conditional probability corresponding to the second target vector may be p(yₜ|E′_{R}). E′_{R} may be the second target vector corresponding to the item. A KL distance may be solved by means of the following formula: .

[symbol]

_{KL}(θ)=D_{KL}(p(yₜ|Hᵢₜₑₘ)∥p(yₜ|E′_{R});θ)

θ may be a parameter, and [symbol] _{KL} (θ) may be the KL distance of the parameter being θ.

As an example, for the trained first item copy-writing generation network, word vector conversion is firstly carried out on the at least one piece of comment information, the attribute information and the title information of a target item to obtain a vector corresponding to the at least one piece of comment information described above, a vector corresponding to the attribute information described above and a vector corresponding to the title information described above. The vector corresponding to the at least one piece of comment information described above, the vector corresponding to the attribute information described above and the vector corresponding to the title information described above are input into an encoding network including a plurality of encoding layers to obtain an encoded vector set corresponding to the at least one piece of comment information described above, an encoded vector set corresponding to the attribute information described above and an encoded vector set corresponding to the title information described above. The encoding network described above is a network in which the plurality of encoding layers are connected in series. Each encoding layer in the encoding network described above corresponds to an encoded output vector. As an example, the encoding network described above may be an encoding network of a transformer model. The encoding network of the transformer model described above includes the plurality of encoding layers.

Then, a vector having the highest weight is selected as the first target vector from the encoded vector set corresponding to the at least one piece of comment information described above. The first target vector described above is input into a pre-trained feedforward neural network, to obtain a first output vector.

Next, according to the encoding layer corresponding to each vector in the encoded vector set corresponding to the attribute information described above and each vector in the encoded vector set corresponding to the title information described above, feature fusion is carried out on the encoded vector set corresponding to the attribute information described above and the encoded vector set corresponding to the title information described above to obtain a fused vector set. The fused vector set is input into an activation function to obtain a second output vector set. The activation function described above may be a Gaussian error linear units (GELU) activation function.

Finally, a vector having the highest weight is selected as a third output vector from the first output vector described above and the second output vector set described above. The third output vector described above and the first output vector described above are added to obtain a first additive vector. The first additive vector described above is normalized to obtain a fourth output vector. The fourth output vector described above is input into the pre-trained feedforward neural network, to obtain a fifth output vector. The fifth output vector described above and the fourth output vector described above are added to obtain a second additive vector. The second additive vector described above is normalized to obtain a sixth output vector as the first target vector output from the trained first item copy-writing generation network.

For the trained first item copy-writing generation network, the second target vector set output from the second item copy-writing generation network described above may correspond to a fifth vector set in the method for generating an item copy-writing described above. In some alternative embodiments of some examples, a loss function of

the initial second item copy-writing generation network described above is generated according to a KL distance formula, a loss function representing correlation between an item copy-writing generated by the first item copy-writing generation network described above and the attribute information of the item, and a loss function representing correlation between an item copy-writing generated by the second item copy-writing generation network described above and the attribute information of the item. As an example, the Loss function of the initial second item copy-writing generation network described above is the following formula:

[symbol]

ₐₗₗ(θ)=α [symbol] _{CoE}(θ)+(1−α)( [symbol] _{RD}(θ)+ [symbol] _{KL}(θ))

[symbol] ₐₗₗ (θ) may be the loss function of the initial second item copy-writing generation network of the parameter being θ. α may be an adjustment parameter and has a numerical range of [0,1]. [symbol] _{CoE}(θ) may be a loss function representing correlation between the item copy-writing generated by the second item copy-writing generation network described above and the attribute information of the item of the parameter being θ. [symbol] _{RD}(θ) may be a loss function representing correlation between the item copy-writing generated by the first item copy-writing generation network described above and the attribute information of the item of the parameter being θ.

[symbol] _{RD}(θ) may be the following formula:

[symbol]

_{RD}(θ)=−log(p(yₜ|E′_{R}); θ)

E′_{R} may be the second target vector corresponding to the target item. yₜ may be a t-th word of a generated target item copy-writing. p(yₜ|E′_{R}) may represent output of a decoding network. θ may be a parameter.

[symbol] _{CoE}(θ) may be the following formula: .

[symbol]

_{CoE}(θ)=−Σₜ₌₁^{|S|}R_{fuse}(y_{<t})·log(p(yᵢ|y_{<t}, T, A; θ))

yₜ may be a t-th word of the generated target item copy-writing. |S| may be the number of words of the generated item copy-writing. y_{<t} may represent a set of words from a first word to a (t−1)-th word of the generated target item copy-writing. T may be the first vector corresponding to the title information. A may be the second vector corresponding to the attribute information. R_{fuse}(y_{<t}) may be a correlation score of each word from the first word to the (t−1)-th word.

R_{fuse}(y_{<t}) is generated by the following formula:

.R_{fuse}(y*)=βR_{Coh}(Y*)+(1−β)R_{RG}(y*)

β may be an adjustment parameter and has a numerical range of [0,1]. y* may be y_{<t}. R_{Coh}(y*) may represent a degree of overlap between the generated y* and the pre-written copy. R_{RG}(y*) may represent a ROUGE score of y*.

R_{Coh}(y*) may be the following formula:

$${R}_{Coh} ( {y}^{*} ) = \frac{{\sum }_{i = 1}^{\vert {y}^{*} \vert} ( f ( {y}_{i}^{*} ) \cdot ℬ \{ {y}_{i}^{*} ∈ {y}_{g} \} )}{{\sum }_{i = 1}^{\vert {y}^{*} \vert} f ( {y}_{i}^{*} )} .$$

|y*| may be the number of words. f( ) may be a word frequency function.

It should be noted that if each word in y* exists in the pre-written item copy-writing as a labeling, [symbol] {y*ᵢ∈y_{g}}=1. If each word in y* exists in the pre-written item copy-writing as a labeling, [symbol] {y*ᵢ∈y_{g}}=0.

Each example described above of the present disclosure has the following beneficial effects: with the method for training an item copy-writing generation network of some examples of the present disclosure, the trained first item copy-writing generation network can guide the initial second item copy-writing generation network to be trained to generate the item copy-writing such that the trained second item copy-writing generation network can accurately and effectively generate the item copy-writing according to the title information of the item and the attribute information of the item. Specifically, comment information on most items is insufficient or valueless, and a high-quality item copy-writing cannot be generated according to the comment information. On this basis, the method for training an item copy-writing generation network of some examples of the present disclosure obtains the item description information of each item in the item set. The item description information described above includes: title information of the item, attribute information of the item, and at least one piece of comment information on the item. Then, data preprocessing is carried out on the item description information set corresponding to the item set described above to obtain the processed item description information set. Herein, data preprocessing on the item description information set described above is configured to remove meaningless comment information and prevent training accuracy of the second item copy-writing generation network from being affected. Further, the initial first item copy-writing generation network is trained to obtain the trained first item copy-writing generation network. The training sample corresponding to the initial first item copy-writing generation network described above includes: the item description information in the processed item description information set described above and the item copy-writing corresponding to the item description information. The item copy-writing described above is pre-written. Herein, the trained first item copy-writing generation network may generate the high-quality item copy-writing according to the input item description information. Finally, with the title information and the attribute information of each piece of item description information in the processed item description information set described above and the item copy-writing corresponding to each piece of item description information as the training sample for the initial second item copy-writing generation network, the initial second item copy-writing generation network described above is trained through the knowledge distillation method, to obtain the trained second item copy-writing generation network according to the trained first item copy-writing generation network described above. The trained first item copy-writing generation network is instructed to guide the initial second item copy-writing generation network to be trained, such that the second item copy-writing generation network can learn some pieces of feature information of generating the high-quality item copy-writing generated from the trained first item copy-writing generation network without relying on the at least one piece of comment information on the input item. Thus, the problem that comment information on most items is insufficient or valueless, and a high-quality item copy-writing cannot be generated according to the comment information can be effectively solved. Thus, the method for training an item copy-writing generation network described above may enable the trained second item copy-writing generation network to accurately and effectively generate the high-quality item copy-writing according to the title information of the item and the attribute information of the item.

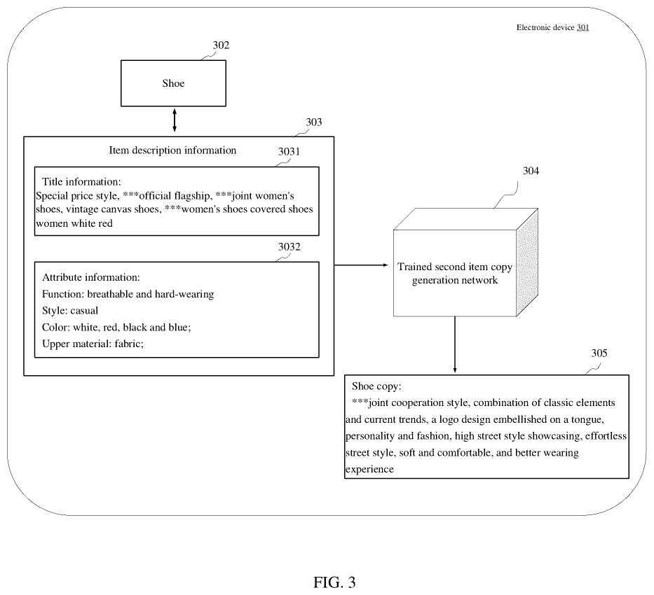

FIG. 3 is a schematic diagram of an application scenario of a method for generating an item copy-writing according to some examples of the present disclosure.

As shown in FIG. 3, an electronic device 301 may obtain title information 3031 and attribute information 3032 of a target item 302, and then input the title information 3031 described above and the attribute information 3032 described above into a trained second item copy-writing generation network 304 to obtain an item copy-writing 305 corresponding to the target item 302 described above. The trained second item copy-writing generation network 304 described above is obtained by training an initial second item copy-writing generation network according to a trained first item copy-writing generation network through a knowledge distillation method. In the application scenario, the target item 302 described above may be “shoes”. The title information 3031 in the item description information 303 described above may be “title information: special price style, ***official flagship, ***joint women's shoes, vintage canvas shoes, ***women's shoes covered shoes women white and red”.

The attribute information 3032 in the item description information 303 described above may be “function: breathable and hard-wearing; style: casual; color: white, red, black and blue; and upper material: fabric”. The item copy-writing 305 described above may be: “shoe copy: ***joint cooperation style, combination of classic elements and current trends, a logo design embellished on a tongue, personality and fashion, high street style showcasing, effortless street style, soft and comfortable, and better wearing experience”.

It should be noted that the electronic device 301 described above may be hardware or software. When the electronic device is the hardware, the electronic device may be implemented as a distributed cluster consisting of a plurality of servers or terminal devices, or may be implemented as a single server or a single terminal device. When the electronic device is embodied as the software, the electronic device may be mounted in the above-listed hardware device. The electronic device may be implemented as a plurality of software or software modules configured to provide a distributed service, for example, or as a single software or software module, which is not specifically limited herein.

It should be understood that the number of electronic devices in FIG. 3 is merely illustrative. Any number of electronic devices may be provided according to implementation requirements.

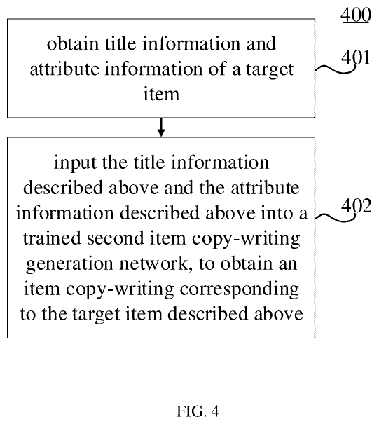

Further, reference is made to FIG. 4 showing a flow 400 of some examples of a method for generating an item copy-writing according to the present disclosure. The method for generating an item copy-writing includes: step 401, obtain title information and attribute information of a target item.

In some examples, an execution body (for example, the electronic device 301 shown in FIG. 3) of the method for generating an item copy-writing may obtain item description information of each item in an item set in a wired connection manner or a wireless connection manner.

Step 402, input the title information described above and the attribute information described above into a trained second item copy-writing generation network, to obtain an item copy-writing corresponding to the target item described above.

In some examples, the execution body described above may input the title information described above and the attribute information described above into the trained second item copy-writing generation network, to obtain the item copy-writing corresponding to the target item described above. The trained second item copy-writing generation network described above is obtained by training an initial second item copy-writing generation network according to a trained first item copy-writing generation network through a knowledge distillation method.

In some alternative embodiments of some examples, the step of inputting the title information described above and the attribute information described above into a trained second item copy-writing generation network, to obtain an item copy-writing corresponding to the target item described above may include:
step 1, carry out word vector conversion on the title information described above and the attribute information described above to obtain a first vector corresponding to the title information described above and a second vector corresponding to the attribute information described above. As an example, the execution body described above may firstly segment the title information described above and the attribute information described above to obtain a word set corresponding to the title information described above and a word set corresponding to the attribute information described above. Then, word embedding processing is carried out on the word set corresponding to the title information described above and the word set corresponding to the attribute information described above to obtain the first vector described above and the second vector described above.
Step 2, encode the first vector described above and the second vector described above to obtain a third vector set corresponding to the title information described above and a fourth vector set corresponding to the attribute information described above.
Step 3, linearly combine, for each third vector in the third vector set and a fourth vector corresponding to the third vector described above, the third vector described above and the fourth vector described above to obtain a fifth vector.
Step 4, decode an obtained fifth vector set, to obtain the item copy-writing corresponding to the target item described above.

Alternatively, the first vector described above and the third vector described above are input into a pre-trained encoding network separately to obtain the third vector set described above and the fourth vector set described above. The encoding network described above includes at least one encoding layer. It should be noted that the encoding network described above is a network in which the plurality of encoding layers are connected in series. Each encoding layer in the encoding network described above corresponds to an encoded output vector.

Alternatively, the step of linearly combining, for each third vector in the third vector set and a fourth vector corresponding to the third vector described above, the third vector described above and the fourth vector described above to obtain a fifth vector may include:

step 1, multiply the third vector described above by a value η, to obtain a first multiplication result. The value η described above is a value between 0 and 1.

Step 2, multiply the fourth vector described above by a value 1−η, to obtain a second multiplication result.

Step 3, add the first multiplication result described above and the second multiplication result described above to obtain the fifth vector described above.

Alternatively, the fifth vector set described above is input into a pre-trained decoding network having a copy mechanism, to obtain the item copy-writing corresponding to the target item described above.

Each example described above of the present disclosure has the following beneficial effects: the method for generating the item copy-writing of some examples of the present disclosure can obtain the title information and the attribute information of the target item, and then input the title information described above and the attribute information described above into the trained second item copy-writing generation network, to obtain an item copy-writing corresponding to the target item such that the high-quality item copy-writing corresponding to the target item described above can be accurately and effectively generated. The trained second item copy-writing generation network described above is obtained by training an initial second item copy-writing generation network according to a trained first item copy-writing generation network through a knowledge distillation method.

Further, reference is made to FIG. 5. As an implementation of the method described above of each figure described above, the present disclosure provides some examples of an apparatus for training an item copy-writing generation network. These apparatus examples correspond to those method examples described above of FIG. 2. The apparatus may be specifically used in various electronic devices.

As shown in FIG. 5, an apparatus 500 for training an item copy-writing generation network of some examples includes: an obtaining unit 501, a preprocessing unit 502, a first training unit 503 and a second training unit 504. The obtaining unit 501 is configured to obtain item description information of each item in an item set. The item description information described above includes: title information of the item, attribute information of the item, and at least one piece of comment information on the item. The preprocessing unit 502 is configured to carry out data preprocessing on an item description information set corresponding to the item set described above to obtain a processed item description information set. The first training unit 503 is configured to train an initial first item copy-writing generation network, to obtain a trained first item copy-writing generation network. A training sample corresponding to the initial first item copy-writing generation network described above includes: item description information in the processed item description information set described above and an item copy-writing corresponding to the item description information. The item copy-writing described above is pre-written. The second training unit 504 is configured to train, according to the trained first item copy-writing generation network described above, an initial second item copy-writing generation network through a knowledge distillation method with the title information and the attribute information of each piece of item description information in the processed item description information set described above and the item copy-writing corresponding to each piece of item description information described above as a training sample for an initial second item copy-writing generation network, to obtain a trained second item copy-writing generation network.

In some alternative embodiments of some examples, the preprocessing unit 502 of the apparatus 500 for training an item copy-writing generation network may be further configured to: determine the number of pieces of the comment information on each piece of item description information in the item description information set described above; remove the item description information of which the number of pieces of the comment information is less than a predetermined threshold from the item description information set described above to obtain a removed item description information set; remove, from each piece of item description information in the removed item description information set described above, comment information of which comment contents satisfy a predetermined condition to generate processed item description information, so as to obtain the processed item description information set described above.

In some alternative embodiments of some examples, the second training unit 504 of the apparatus 500 for training an item copy-writing generation network may be further configured to: train the initial second item copy-writing generation network described above with a KL distance set between a conditional probability corresponding to a first target vector output from the trained first item copy-writing generation network described above and a conditional probability set corresponding to a second target vector set output from the second item copy-writing generation network described above as a training constraint condition to obtain the trained second item copy-writing generation network described above.

Understandably, the units described in the apparatus 500 correspond to the steps in the method described with reference to FIG. 2. Thus, operations, features, and generated beneficial effects described above for the method are also suitable for the apparatus 500 and the units included in the apparatus, which will not be repeated herein.

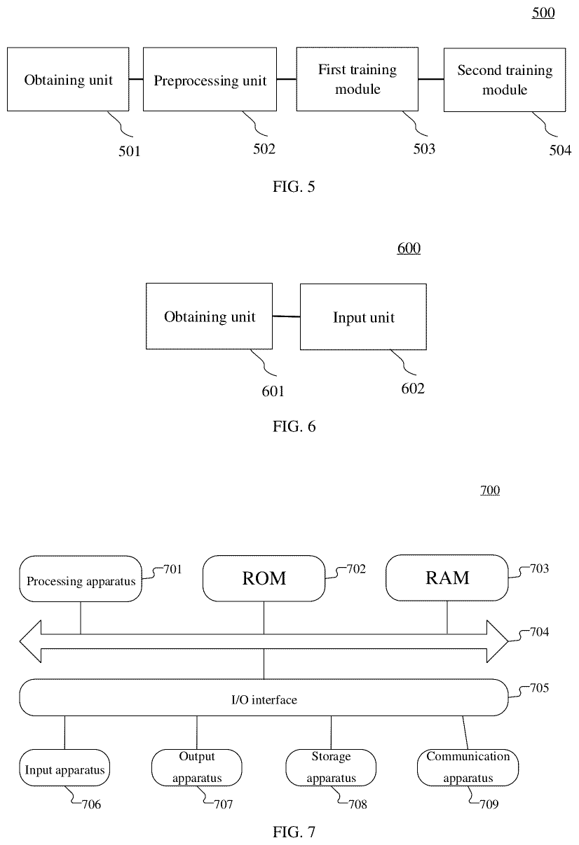

Further, reference is made to FIG. 6. As an implementation of the method described above of each figure described above, the present disclosure provides some examples of an apparatus for generating an item copy-writing. These apparatus examples correspond to those method examples described above of FIG. 4. The apparatus may be specifically used in various electronic devices.

As shown in FIG. 6, an apparatus 600 for generating an item copy-writing of some examples includes: an obtaining unit 601 and an input unit 602. The obtaining unit 601 is configured to obtain title information and attribute information of a target item. The input unit 602 is configured to input the title information described above and the attribute information described above into a trained second item copy-writing generation network, to obtain an item copy-writing corresponding to the target item described above. The trained second item copy-writing generation network described above is obtained by training an initial second item copy-writing generation network according to a trained first item copy-writing generation network through a knowledge distillation method.

In some alternative embodiments of some examples, the input unit 602 of the apparatus 600 for generating an item copy-writing may be further configured to: carry out word vector conversion on the title information described above and the attribute information described above to obtain a first vector corresponding to the title information described above and a second vector corresponding to the attribute information described above; encode the first vector described above and the second vector described above to obtain a third vector set corresponding to the title information described above and a fourth vector set corresponding to the attribute information described above; linearly combine, for each third vector in the third vector set and a fourth vector corresponding to the third vector described above, the third vector described above and the fourth vector described above to obtain a fifth vector; and decode an obtained fifth vector set, to obtain an item copy-writing corresponding to the target item described above.

In some alternative embodiments of some examples, the input unit 602 of the apparatus 600 for generating an item copy-writing may be further configured to: input the first vector described above and the third vector described above into a pre-trained encoding network separately to obtain the third vector set described above and the fourth vector set described above. The encoding network described above includes at least one encoding layer. In some alternative embodiments of some examples, the input unit 602 of the apparatus 600 for generating an item copy-writing may be further configured to: multiply the third vector described above by a value η, to obtain a first multiplication result, where the value η is a value between 0 and 1; multiply the fourth vector by a value 1−η, to obtain a second multiplication result; and add the first multiplication result and the second multiplication result, to obtain the fifth vector.

In some alternative embodiments of some examples, the input unit 602 of the apparatus 600 for generating an item copy-writing may be further configured to: input the fifth vector set described above into a pre-trained decoding network having a copy mechanism, to obtain the item copy-writing corresponding to the target item described above.

Understandably, the units described in the apparatus 600 correspond to the steps in the method described with reference to FIG. 4. Thus, operations, features, and generated beneficial effects described above for the method are also suitable for the apparatus 600 and the units included in the apparatus, which will not be repeated herein.

Reference is made to FIG. 7 showing a schematic structural diagram of an electronic device (for example, the electronic device in FIG. 1 or 3) 700 suitable for implementing some examples of the present disclosure below. The electronic device shown in FIG. 7 is only an example and should not impose any limitation to functions and the scope of use of the examples of the present disclosure.

As shown in FIG. 7, the electronic device 700 may include a processing apparatus (for example, a central processor and a graphics processor) 701. The processing apparatus may execute various suitable actions and processes according to programs stored in a read-only memory (ROM) 702 or programs loaded from a storage apparatus 708 into a random access memory (RAM) 703. The RAM 703 further stores various programs and data required for operation of the electronic device 700. The processing apparatus 701, the ROM 702, and the RAM 703 are connected to each other by means of a bus 704. An input/output (I/O) interface 705 is also connected to the bus 704.

Typically, the following apparatuses may be connected to the I/O interface 705: input apparatuses 706 including a touch screen, a touchpad, a keyboard, a mouse, a camera, a microphone, an accelerometer and a gyroscope, for example; output apparatuses 707 including a liquid crystal display (LCD), a speaker and a vibrator, for example; the storage apparatus 708 including a magnetic tape and a hard drive, for example; and a communication apparatus 709, for example. The communication apparatus 709 may allow the electronic device 700 to perform wireless or wired communication with other devices to exchange data. Although FIG. 7 shows the electronic device 700 having various apparatuses, it should be understood that it is not required to implement or provide all the shown apparatuses. More or less apparatuses may be alternatively implemented or provided. Each box shown in FIG. 7 may represent one apparatus or multiple apparatuses as required.

Particularly, according to some examples of the present disclosure, a process described above with reference to the flow chart may be implemented as a computer software program. For example, some examples of the present disclosure include a computer program product. The computer program product includes a computer program carried on a computer-readable medium. The computer-readable medium includes program codes configured to execute the method shown in the flow chart. In some examples, the computer program may be downloaded and mounted from a network by means of the communication apparatus 709, mounted from the storage apparatus 708, or mounted from the ROM 702. When the computer program is executed by the processing apparatus 701, the functions described above and limited in the method of some examples of the present disclosure are executed.

It should be noted that the computer-readable medium described above in some examples of the present disclosure may be a computer-readable signal medium, a computer-readable storage medium, or any combination of the computer-readable signal medium and the computer-readable storage medium. The computer-readable storage medium may be, for example, but not limited to, systems, apparatuses or devices of electricity, magnetism, light, electromagnetism, infrared or semiconductors, or any combination of the above. More specific examples of the computer-readable storage medium may include, but not limited to: an electrically connected and portable computer disk having one or more wires, a hard drive, a RAM, a ROM, an erasable programmable read-only memory (EPROM or flash memory), an optical fiber, a portable compact disk read-only memory (CD-ROM), an optical storage device, a magnetic storage device, or any suitable combination of the above. In some examples of the present disclosure, the computer-readable storage medium may be any tangible medium including or storing a program. The program may be used by or in combination with an instruction execution system, apparatus or device. In some examples of the present disclosure, the computer-readable signal medium may include a data signal propagated in a baseband or as part of a carrier. The data signal carries computer-readable program codes. The data signal propagating may take various forms, including, but not limited to, an electromagnetic signal, an optical signal, or any suitable combination of the above. The computer-readable signal medium may further be any computer-readable medium apart from the computer-readable storage medium, and the computer-readable signal medium may send, propagate, or transmit programs used by the instruction execution system, apparatus, or device or in combination with the instruction execution system, apparatus, or device. Program codes included on the computer-readable medium may be transmitted by using any suitable medium that includes, but not limited to, wire, optical cable, radio frequency (RF), etc., or any suitable combination of the above.

In some embodiments, a client and a server may communicate by utilizing any currently known or future developed network protocol such as a hyperText transfer protocol (HTTP), and may interconnect with digital data communication (for example, communication network) in any form or medium. An example of the communication network includes a local area network (“LAN”), a wide area network (“WAN”), an Internet work (for example, the Internet), an end-to-end network (for example, ad hoc end-to-end network), as well as any currently known or future developed network.

The computer-readable medium described above may be included in the apparatus described above, or exist separately without being assembled into the electronic device. The computer-readable medium described above carries one or more programs. When the one or more programs are executed by the electronic device, the electronic device obtains item description information of each item in an item set, where the item description information described above includes: title information of the item, attribute information of the item, and at least one piece of comment information on the item; carries out data preprocessing on an item description information set corresponding to the item set described above to obtain a processed item description information set; trains an initial first item copy-writing generation network, to obtain a trained first item copy-writing generation network, where a training sample corresponding to the initial first item copy-writing generation network described above includes: item description information in the processed item description information set described above and an item copy-writing corresponding to the item description information, where the item copy-writing described above is pre-written; and with the title information and the attribute information of each piece of item description information in the processed item description information set described above and the item copy-writing corresponding to each piece of item description information described above as a training sample for an initial second item copy-writing generation network, trains, according to the trained first item copy-writing generation network, the initial second item copy-writing generation network described above through a knowledge distillation method, to obtain a trained second item copy-writing generation network. The electronic device obtains title information and attribute information of a target item; and inputs the title information described above and the attribute information described above into the trained second item copy-writing generation network, to obtain an item copy-writing corresponding to the target item, where the trained second item copy-writing generation network described above is obtained by training an initial second item copy-writing generation network according to a trained first item copy-writing generation network through a knowledge distillation method. Computer program codes configured to execute operations of some

examples of the present disclosure may be written in one or more programming languages or a combination of the programming languages. The programming languages described above include object-oriented programming languages such as Java, Smalltalk and C++, and further include conventional procedural programming languages such as “C” programming language or similar programming languages. The program codes may be executed entirely on a user computer, executed partially on a user computer, executed as a stand-alone software package, executed partially on the user computer and partially on a remote computer, or executed entirely on the remote computer or a server. Where the remote computer is involved, the remote computer may be connected to the user computer by means of any kind of network, including the LAN or the WAN, or may be connected to an external computer (for example, the remote computer is connected by means of the Internet by an Internet service provider).

It should be noted that flow diagrams and block diagrams in the accompanying drawings illustrate system structures, functions and operations, which may be implemented according to systems, methods and computer program products according to various examples of the present disclosure. In this regard, each block in flow diagrams or block diagrams may represent a module, a program segment, or a part of a code, which may include one or more executable instructions configured to implement logical functions specified. It should also be noted that in some alternative implementations, functions noted in the blocks may also occur in sequences different from those in the accompanying drawings. For example, the functions represented by two continuous blocks may be actually implemented basically in parallel, sometimes implemented in reverse sequences, which depends on the involved functions. It should also be noted that each block in the block diagrams and/or the flow diagrams, and combinations of the blocks in the flow diagrams and/or the block diagrams may be implemented by using dedicated hardware-based systems that implement the specified functions or operations, or may be implemented by using combinations of dedicated hardware and computer instructions.

Units described in some examples of the present disclosure can be implemented by means of software or hardware. The described unit can also be arranged in the processor, for example, the described unit can be described as: a processor including an obtaining unit, a preprocessing unit, a first training unit, and a second training unit. The names of these units do not constitute a limitation on the unit itself in some cases. For example, the obtaining unit can further be described as the “unit that obtains item description information of each item in an item set”.

The functions described above herein can be at least partially executed by one or more hardware logic components. For example, demonstrative hardware logic components that can be used without limitations include: a field programmable gate array (FPGA), an application specific integrated circuit (ASIC), an application specific standard products (ASSP), a system on chip (SOC), a complex programmable logic device (CPLD), etc.

The description described above is only for illustration of some preferred examples of the present disclosure and the technical principles used. It should be understood by those skilled in the art that the scope of the invention involved in the examples of the present disclosure is not limited to the technical solution formed by a specific combination of the technical features described above, and should also cover other technical solutions formed by any combination of the technical features described above or equivalent features of the features without departing from the inventive concept described above, for example, the technical solution formed by mutually replacing the features described above with the technical features (but not limited to) having similar functions disclosed in the examples of the present disclosure.

1. A method for training an item copy-writing generation network, comprising:
obtaining item description information of each item in an item set, wherein the item description information comprises: title information of the item, attribute information of the item, and at least one piece of comment information on the item;
carrying out data preprocessing on an item description information set corresponding to the item set, to obtain a processed item description information set;
training an initial first item copy-writing generation network, to obtain a trained first item copy-writing generation network, wherein a training sample corresponding to the initial first item copy-writing generation network comprises: item description information in the processed item description information set and an item copy-writing corresponding to the item description information, wherein the item copy-writing is pre-written; and
with the title information and the attribute information of each piece of item description information in the processed item description information set and the item copy-writing corresponding to each piece of item description information as a training sample for an initial second item copy-writing generation network, training, according to the trained first item copy-writing generation network, the initial second item copy-writing generation network through a knowledge distillation method, to obtain a trained second item copy-writing generation network.

2. The method according to claim 1, wherein the carrying out data preprocessing on an item description information set corresponding to the item set, to obtain a processed item description information set comprises:
determining the number of pieces of the comment information on each piece of item description information in the item description information set;
removing the item description information of which the number of pieces of the comment information is less than a predetermined threshold from the item description information set, to obtain a removed item description information set; and
removing, from each piece of item description information in the removed item description information set, comment information of which comment contents satisfy a predetermined condition to generate processed item description information, so as to obtain the processed item description information set.

3. The method according to claim 1, wherein the training, according to the trained first item copy-writing generation network, the initial second item copy-writing generation network through a knowledge distillation method, to obtain a trained second item copy-writing generation network comprises:
with a Kullback Leibler (KL) distance set between a conditional probability corresponding to a first target vector output from the trained first item copy-writing generation network and a conditional probability set corresponding to a second target vector set output from the second item copy-writing generation network as a training constraint condition, training the initial second item copy-writing generation network, to obtain the trained second item copy-writing generation network.

4. The method according to claim 1, wherein a loss function of the initial second item copy-writing generation network is generated according to a KL distance formula, a loss function representing correlation between an item copy-writing generated by the first item copy-writing generation network and the attribute information of the item, and a loss function representing correlation between an item copy-writing generated by the second item copy-writing generation network and the attribute information of the item.

5. A method for generating an item copy-writing, comprising:
obtaining title information and attribute information of a target item; and
inputting the title information and the attribute information into a trained second item copy-writing generation network, to obtain an item copy-writing corresponding to the target item, wherein the trained second item copy-writing generation network is obtained by training an initial second item copy-writing generation network according to a trained first item copy-writing generation network through a knowledge distillation method.

6. The method according to claim 5, wherein the inputting the title information and the attribute information into a trained second item copy-writing generation network, to obtain an item copy-writing corresponding to the target item comprises:
carrying out word vector conversion on the title information and the attribute information, to obtain a first vector corresponding to the title information and a second vector corresponding to the attribute information;
encoding the first vector and the second vector, to obtain a third vector set corresponding to the title information and a fourth vector set corresponding to the attribute information;
linearly combining, for each third vector in the third vector set and a fourth vector corresponding to the third vector, the third vector and the fourth vector, to obtain a fifth vector; and
decoding an obtained fifth vector set, to obtain an item copy-writing corresponding to the target item.

7. The method according to claim 6, wherein the encoding the first vector and the second vector, to obtain a third vector set corresponding to the title information and a fourth vector set corresponding to the attribute information comprises:
inputting the first vector and the third vector separately into a pre-trained encoding network, to obtain the third vector set and the fourth vector set, wherein the encoding network comprises at least one encoding layer.

8. The method according to claim 6, wherein the linearly combining, for each third vector in the third vector set and a fourth vector corresponding to the third vector, the third vector and the fourth vector, to obtain a fifth vector comprises:
multiplying the third vector by a value η, to obtain a first multiplication result, wherein the value η is a value between 0 and 1;
multiplying the fourth vector by a value 1−η, to obtain a second multiplication result; and
adding the first multiplication result to the second multiplication result, to obtain the fifth vector.

9. The method according to claim 6, wherein the decoding an obtained fifth vector set, to obtain an item copy-writing corresponding to the target item comprises:
inputting the fifth vector set into a pre-trained decoding network having a copy mechanism, to obtain the item copy-writing corresponding to the target item.

10. (canceled)

11. (canceled)

12. An electronic device, comprising:
at least one processor; and
a storage apparatus configured to store at least one program, wherein
when the at least one program are executed by the at least one processor, the at least one processor implement a method for training an item copy-writing generation network, comprising:
obtaining item description information of each item in an item set, wherein the item description information comprises: title information of the item, attribute information of the item, and at least one piece of comment information on the item;
carrying out data preprocessing on an item description information set corresponding to the item set, to obtain a processed item description information set;
training an initial first item copy-writing generation network, to obtain a trained first item copy-writing generation network, wherein a training sample corresponding to the initial first item copy-writing generation network comprises: item description information in the processed item description information set and an item copy-writin cg orresponding to the item description information, wherein the item copy-writing is pre-written; and
with the title information and the attribute information of each piece of item description information in the processed item description information set and the item copy-writing corresponding to each piece of item description information as a training sample for an initial second item copy-writing generation network, training, according to the trained first item copy-writing generation network, the initial second item copy-writing generation network through a knowledge distillation method, to obtain a trained second item copy-writing generation network.

13. A non-volatile computer-readable medium, storing a computer program, wherein the program implements the method of claim 1 when executed by a processor.

14. The method according to claim 2, wherein the training, according to the trained first item copy-writing generation network, the initial second item copy-writing generation network through a knowledge distillation method, to obtain a trained second item copy-writing generation network comprises:
with a Kullback Leibler (KL) distance set between a conditional probability corresponding to a first target vector output from the trained first item copy-writing generation network and a conditional probability set corresponding to a second target vector set output from the second item copy-writing generation network as a training constraint condition, training the initial second item copy-writing generation network, to obtain the trained second item copy-writing generation network.

15. The method according to claim 2, wherein a loss function of the initial second item copy-writing generation network is generated according to a KL distance formula, a loss function representing correlation between an item copy-writing generated by the first item copy-writing generation network and the attribute information of the item, and a loss function representing correlation between an item copy-writing generated by the second item copy-writing generation network and the attribute information of the item.

16. The method according to claim 3, wherein a loss function of the initial second item copy-writing generation network is generated according to a KL distance formula, a loss function representing correlation between an item copy-writing generated by the first item copy-writing generation network and the attribute information of the item, and a loss function representing correlation between an item copy-writing generated by the second item copy-writing generation network and the attribute information of the item.

17. An electronic device, comprising:
at least one processor; and
a storage apparatus configured to store at least one program, wherein
when the at least one program are executed by the at least one processor, the at least one processor implement the method of claim 5.

18. An electronic device, comprising:
at least one processor; and
a storage apparatus configured to store at least one program, wherein
when the at least one program are executed by the at least one processor, the at least one processor implement the method of claim 6.

19. An electronic device, comprising:
at least one processor; and
a storage apparatus configured to store at least one program, wherein
when the at least one program are executed by the at least one processor, the at least one processor implement the method of claim 7.

20. A non-volatile computer-readable medium, storing a computer program, wherein the program implements the method of claim 5 when executed by a processor.

21. A non-volatile computer-readable medium, storing a computer program, wherein the program implements the method of claim 6 when executed by a processor.

22. A non-volatile computer-readable medium, storing a computer program, wherein the program implements the method of claim 7 when executed by a processor.
